(19) United States
(12) Patent Application Publication
(10) Pub. No.: US 2021/0143728 A1
(43) Pub. Date: May 13, 2021

(54) REGULATOR BYPASS SWITCHING ASSEMBLY

(71) Applicant: Eaton Intelligent Power Limited, Dublin (IE)

(72) Inventors: Gaurav Patwardhan, Aurangabad (IN); Richard Kaluzny, Greenfield, WI (US); Randal Malliet, Waukesha, WI (US); Daniel Daley, Waukesha, WI (US); Shivanand Desai Gaonkar, Goa (IN); Amol Jadhav, Parbhani (IN); Ojal Jawale, Nasik (IN); Adam Vannieuwenhoven, Glendale Heights, IL (US)

(21) Appl. No.: 17/091,248

(22) Filed: Nov. 6, 2020

Related U.S. Application Data
(60) Provisional application No. 62/933,564, filed on Nov. 11, 2019.

(51) Int. Cl. H02M 1/32; H01H 9/20; H01H 9/02; H01H 1/58

(52) U.S. Cl. CPC H02M 1/32; H01H 9/20; H01H 3/46; H01H 1/58; H01H 9/0271

(57) ABSTRACT

A bypass switching assembly includes a source terminal configured for connection to an electrical source; a load terminal configured for connection to a load; a switch including: a first electrically conductive element, a second electrically conductive element, and an electrically conductive bypass element; and an interlock assembly including: an insulator configured to rotate; and a locking assembly configured to interact with the insulator to prevent movement or permit movement of at least one of the first electrically conductive element and the second electrically conductive element.

### CROSS-REFERENCE TO RELATED APPLICATION

This application claims the benefit of U.S. Provisional Application No. 62/933,564, filed on Nov. 11, 2019 and titled REGULATOR BYPASS SWITCHING ASSEMBLY, which is incorporated herein by reference in its entirety.

### TECHNICAL FIELD

This disclosure relates to a regulator bypass switching assembly. The bypass switching assembly may be used with a voltage regulation device such as, for example, a load tap changer, a line voltage regulator, or a step voltage regulator.

### BACKGROUND

Voltage regulation devices are used to monitor and control a voltage level in an electrical power distribution system. A bypass switch is used to connect and disconnect the voltage regulation device from the electrical power distribution system.

### SUMMARY

In one aspect, a bypass switching assembly includes a source terminal configured for connection to an electrical source; a load terminal configured for connection to a load; a switch including: a first electrically conductive element, a second electrically conductive element, and an electrically conductive bypass element; and an interlock assembly including: an insulator configured to rotate, and a locking assembly configured to interact with the insulator to prevent movement or permit movement of at least one of the first electrically conductive element and the second electrically conductive element.

Implementations may include one or more of the following features.

The interlock assembly also may include a sensor configured to: sense a position of the insulator and generate an indication of the position of the insulator, and the locking assembly may prevent or permit movement based on the indication of the position of the insulator.

The switch may have at least a closed state and an opened state; and in the closed state, the first electrically conductive element is electrically connected to the source terminal, the second electrically conductive element is electrically connected to the load terminal, and the electrically conductive bypass element is not electrically connected to the source terminal and the load terminal; and in the open state, the first electrically conductive element is not electrically connected to the source terminal, the second electrically conductive element is not electrically connected to the load terminal, and the electrically conductive bypass element is electrically connected to the source terminal and the load terminal.

The bypass switching assembly also may include a pivot assembly, the first electrically conductive element and the second electrically conductive element may be coupled to the pivot assembly, and the insulator may extend along a longitudinal axis from a base to a top end portion. The first and second electrically conductive elements may rotate about the pivot assembly in a plane that is perpendicular to the longitudinal axis. At least one of the first electrically conductive element and the second electrically conductive element may be mechanically coupled to the insulator, and the locking assembly may be configured to prevent movement of at least one of the first and second electrically conductive elements by engaging the base and to permit movement of at least one of the first and second electrically conductive elements by disengaging the base. The locking assembly may include a linear actuator with a plunger, the base may include openings configured to receive the plunger, and the actuator may be configured to prevent movement of the insulator and at least one of the first electrically conductive element and the second electrically conductive element by moving the plunger into one of the openings. The bypass switching assembly also may include a sensor mechanically coupled to the base and configured to provide an indication of a position of the insulator.

In some implementations, the first and second electrically conductive elements rotate about the pivot assembly in a plane that is parallel to the longitudinal axis. The locking assembly may include a hook mechanically connected to the top end portion of the insulator such that the hook rotates with the insulator, and the hook may be configured to latch into one of a plurality of holes on a disk to thereby restrict movement of one or more of the first electrically conductive element and the second electrically conductive element.

The bypass switching assembly also may include a motor configured to cause the insulator to rotate.

The first electrically conductive element and the second electrically conductive element may be configured to move independently of each other.

The first electrically conductive element and the second electrically conductive element may be mechanically coupled to each other such that the conductive elements are configured to move together.

The bypass switching assembly also may include a gear system coupled to the insulator and to one or more of the first electrically conductive element and the second electrically conductive element. The gear system may include a first gear mounted on the insulator and a second gear coupled to the first gear, and the second gear may be coupled to one or more of the first electrically conductive element and the second electrically conductive element. The first gear may be a pinion gear, and the second gear may be a rack gear. The gear system may transfer rotational motion of the insulator to one or more of the first electrically conductive element and the second electrically conductive element such that the motion of one or more of the first electrically conductive element and the second electrically conductive element is controllable by controlling the actuator. The bypass switching assembly also may include an actuator configured to cause the insulator to rotate. The actuator may be a motor. The locking mechanism may include a linear actuator and a plunger, and the insulator may include openings configured to receive the plunger.

In some implementations, the first electrically conductive element is electrically connected to a source bushing of a voltage regulator, and the second electrically conductive element is electrically connected to a load bushing of the voltage regulator; and the bypass switching assembly further includes a control system coupled to the actuator and the sensor. In these implementations, the control system is configured to analyze the generated indication of the position of the insulator and an electrical measurement of the voltage regulator and to control the actuator based on the indicated position of the insulator and the electrical measurement of the voltage regulator.

The bypass switching assembly also may include a motor. The insulator may be rotated by the motor. The motor may act as the locking assembly. The motor may be controllable from a remote system that is external to the bypass switching assembly. The remote system may be remotely connected to a transceiver in the bypass switching assembly via a wireless connection or a physical tether.

One or more of the first electrically conductive element and the second electrically conductive element may be moved by the insulator.

The source terminal may include a first material having a first impedance, the load terminal may include a material having a second impedance, a portion of the source terminal may include a first substance that has a greater electrical impedance than the first impedance, and a portion of the load terminal may include a second substance that has a greater electrical impedance than the second impedance. The first substance and the second substance may be a resistive coating. The coating may be a copper alloy. The first substance and the second substance may be a ridged or roughened surface on a portion of the source terminal and a portion of the load terminal.

In another aspect, a system includes a voltage regulator, a bypass switching assembly, and a control system coupled to the voltage regulator and the bypass switching assembly. The voltage regulator includes: a source bushing, a load bushing, and a winding between the source bushing and the load bushing. The bypass switching assembly includes: a source terminal configured for connection to an electrical source; a load terminal configured for connection to a load; a switch including: a first electrically conductive element electrically connected to the source bushing of the voltage regulator and configured to be connected to or disconnected from the source terminal of the bypass switching assembly, a second electrically conductive element electrically connected to the load bushing of the voltage regulator and configured to be connected to or disconnected from the load terminal of the bypass switching assembly, and an electrically conductive bypass element; an interlock assembly including: an insulator configured to rotate, and a locking assembly configured to prevent movement or permit movement of at least one of the first electrically conductive element and the second electrically conductive element. The control system is configured to: determine whether the voltage regulator is in a safe to bypass state, and to only allow the interlock assembly to permit movement when the voltage regulator is in the safe to bypass state.

Implementations of any of the techniques described herein may include a bypass switching assembly, a system that includes a bypass switching assembly and a voltage regulation device, a control system for controlling a bypass switching apparatus, software stored on a non-transitory computer readable medium that, when executed, controls a bypass switching apparatus, a kit for retrofitting a voltage regulation device or a bypass switching apparatus, and/or a method. The details of one or more implementations are set forth in the accompanying drawings and the description below. Other features will be apparent from the description and drawings, and from the claims.

### DRAWING DESCRIPTION

FIG. 1A is a block diagram of an electrical power distribution system.

FIG. 1B is a block diagram of an insulator.

FIGS. 2A, 2C, and 2E are perspective views of a bypass switching apparatus.

FIG. 2B is a side view of part of an interlock assembly that may be used in the bypass switching apparatus of FIGS. 2A, 2C, and 2E.

FIGS. 2D and 2F are perspective views of part of the interlock assembly of FIG. 2B.

FIGS. 3A and 3B are perspective views of another bypass switching apparatus.

FIGS. 3C and 3D are side views of a bypass element that may be used in the bypass switching apparatus of FIGS. 3A and 3B.

FIG. 4A is a side view of another bypass switching apparatus.

FIG. 4B is a side view of an interlock assembly that may be used in the bypass switching apparatus of FIG. 4A.

FIGS. 4C and 4E are perspective views of the bypass switching assembly of FIG. 4A.

FIGS. 4D and 4F show a portion of the interlock assembly of FIG. 4B.

FIGS. 5A and 5B are side and top-down views, respectively, of another bypass switching apparatus.

FIGS. 6A and 6B are top-down and side views, respectively, of another bypass switching apparatus.

FIG. 7 is a perspective view of a source terminal and a load terminal.

FIGS. 8A and 8B are perspective and side views, respectively, of another bypass switching apparatus.

### DETAILED DESCRIPTION

A bypass switching assembly for a voltage regulator is disclosed. FIG. 1A is a block diagram of a bypass switching assembly 120 in an electrical power distribution system 100. The bypass switching assembly 120 includes an interlock assembly 135 that is controllable to lock or unlock the bypass switching assembly 120, as discussed further below. The bypass switching assembly 120 allows a voltage regulation system 108 to be disconnected from or connected to the electrical power distribution system 100. The bypass switching assembly 120 includes a source terminal 122 that is electrically connected to a power source 101 via a distribution path 106, and a load terminal 124 that is electrically connected to an electrical load 102 via the distribution path 106.

The voltage regulation device 108 monitors and controls the voltage level in the electrical power distribution system 100. For example, the voltage regulation device 108 may be used to maintain a steady-state voltage of the electrical power distribution system 100, or a portion of the system 100, within a voltage range such that the voltage level at the load 102 also stays within an acceptable range. The voltage regulation device 108 may be any type of electrical, mechanical, or electro-mechanical device that is capable of performing a voltage regulation operation that changes the voltage on the distribution path 106. The voltage regulation device 108 may be, for example, a on load-tap changer (OLTC) or a step voltage regulator. The voltage regulation device 108 includes a source bushing 109, a load bushing 110, and a coil 112 between the source bushing 109 and the load bushing 110. The coil 112 includes taps 113. The voltage regulation device 108 also includes tap selector 114 that includes electrical contacts (not shown) that are movable relative to the coil 112 and the taps 113. The amount of voltage provided to the load 102 depends on which of the taps 113 are in electrical contact with the tap selector 114. The voltage regulation device 108 also includes various sensors and measuring devices 115. The sensors 115 may be, for example, current and/or voltage sensors.

The tap selector 114 is controlled by a control system 150. The control system 150 receives data from the sensors 115 and analyzes the data to determine various electrical conditions in the voltage regulation device 108, such as the voltage difference between the source bushing 109 and the load bushing 110. The control system 150 uses the measured electrical conditions in the voltage regulation device 108 to determine whether or not the voltage regulation device 108 may be safely disconnected from or connected to the electrical power distribution system the electrical power distribution system 100.

The bypass switching assembly 120 includes a first electrically conductive element 126, a second electrically conductive element 128, and an electrically conductive bypass element 130. The first electrically conductive element 126, the second electrically conductive element 128, and the bypass element 130 are made of an electrically conductive material, such as copper or any other metallic material. The first electrically conductive element 126 is electrically connected to the source bushing 109. The second electrically conductive element 128 is electrically connected to the load bushing 110.

The bypass switching assembly 120 has a closed state and an opened state. When the bypass switching assembly 120 is in the closed state, the voltage regulation device 108 is connected to the electrical power distribution system 100. In the closed state, the first electrically conductive element 126 is electrically connected to the source terminal 122 and the second electrically conductive element 128 is electrically connected to the load terminal 124. Electrical current flows from the source 101 into the first electrically conducting element 126, into the coil 112, into the second electrically conducting element 128, and to the load 102. When the bypass switching assembly 120 is in the opened state, the voltage regulation device 108 is disconnected from the electrical power distribution system 100. In the opened state, the electrically conductive bypass element 130 electrically connects the source terminal 122 and the load terminal 124. Furthermore, in the opened state, the second electrically conductive element 128 is not electrically connected to the load terminal 124, and the first electrically conductive element 126 is not electrically connected to the source terminal 122. When the bypass switching assembly 120 is in the opened state, the voltage regulation device 108 is “bypassed” by the bypass switching assembly 120.

In some implementations, the first electrically conductive element 126 and the second electrically conductive element 128 are able to move independently of each other. In these implementations, to close the bypass switching assembly 120, the first electrically conductive element 126 is connected to the source terminal 122 before connecting the second electrically conductive element 128 to the load terminal 124. Connecting the first electrically conductive element 126 to the source terminal 122 first provides power to the coil 112 in the voltage regulation device 108 such that the control system 150 is able to determine whether the voltage regulator may be safely connected to the electrical power distribution system 100. In these implementations, to disconnect the voltage regulation device 108 from the system 100, the second electrically conductive element 128 is removed from the load terminal 124 before the first electrically conductive element 126 is removed from the source terminal 122.

The bypass switching assembly 120 includes the interlock assembly 135. The interlock assembly 135 includes an insulator 136 and a locking assembly 138. Referring also to FIG. 1B, the insulator 136 is a three-dimensional body that extends along a longitudinal axis 131 from a base 141 to a top end portion 142. The insulator 136 is rotatable about the longitudinal axis 131. For example, the insulator 136 may be mounted on a platform, post, axle, or spindle that allows the insulator 136 to rotate about the axis 131. Then bypass switching assembly 120 also may include an actuator 133 that causes the insulator 136 to rotate about the axis 131. The actuator 133 may be an electrical actuator (such as a motor) that is controllable by the control system 150 or an actuator that is configured for manual operation by a human operator (for example, an actuator that is configured to be activated by a hook stick).

The first and second electrically conductive elements 126 and 128, or just the second electrically conductive element 128, are coupled to the interlock assembly 135. The interlock assembly 135 restricts the motion of one or more of the first electrically conductive element 126 and the second electrically conductive element 128 to prevent unintentional or unsafe operation of the bypass switching assembly 120.

The interlock assembly 135 also may include a sensor 137. In implementations that include the sensor 137, the sensor 137 determines a position of the first and second electrically conductive elements 126, 128 or a structure connected to the elements 126 and/or 128. For example, in some implementations, the electrically conductive elements 126 and 128 are mounted to the insulator 136. In these implementations, the sensor 137 measures or tracks the position of the insulator 136 (for example, by measuring the amount of rotation) and thus also measures or tracks the position of the first and second conductive elements 126 and 128. The sensor 137 is any type of sensor capable of tracking or measuring the position of the electrically conductive elements 126 and 128 or the rotating insulator 136. For example, the sensor 137 may be a limit switch. The sensor 137 provides an indication of the position to the control system 150.

The bypass switching assembly 120 does not necessarily include the sensors 137. For example, the actuator 133 may include a transceiver or other communications interface that allows the actuator 133 to communicate with the control system 150 and external electronic devices. In implementations in which the actuator 133 is capable of communicating with the control system 150 or being monitored directly by the control system 150, the motion of the insulator 136 is tracked by information provided by the actuator 133 instead of the sensors 137. For example, the actuator 133 may be a motor that communicate its position or the distance rotated to the control system 150. In these implementations, the bypass switching assembly 120 may be constructed without the sensors 137.

The locking assembly 138 is any device that is capable of locking the electrically conductive elements 126 and 128 in place or locking a structure that is physically connected to the elements 126 and 128 in place. For example, the locking assembly 138 may be a linear actuator that includes a plunger, a hook that locks a rotating disk in place, or an electric motor or gear system that is connected to the insulator 136 and is lockable in a particular position.

The control system 150 analyzes the position (from the sensors 137 and/or the actuator 133) and determines whether to lock the position of the first and second electrically conductive elements 126 and 128. The determination may be based on the position of the first and second electrically conductive elements 126 and 128. For example, before locking the elements 126 and 128 in the opened position, the control system 150 may determine whether or not the insulator 136 has rotated through a distance sufficient to remove the elements 126 and 128 from the source terminal 122 and load terminal 124, respectively. Before locking the elements 126 and 128 in the closed position, the control system 150 may analyze information from the sensor 137 to determine whether or not the elements 126 and 128 are in contact with the source terminal 122 and the load terminal 124, respectively. The control system 150 may use the position information related to the insulator 136 to determine whether or not the electrically conducting elements 126 and 128 are locked or unlocked.

The control system 150 also may use information from the voltage regulation device 108. For example, the control system 150 only enables the first and second electrically conductive elements 126 and 128 to move when the conditions in the voltage regulation device 108 indicate that a bypass may be safely performed. The voltage regulation device 108 is generally safe to bypass when in a neutral position or state, or when the voltage difference between the source bushing 109 and the load bushing 110 is zero. The control system 150 may determine whether safe to bypass conditions exist based on information from the sensors 115.

The control system 150 includes an electronic processing module 151, an electronic storage 152, and an input/output (I/O) interface 153. The electronic processing module 151 includes one or more electronic processors. The electronic processors of the module 151 may be any type of electronic processor and may or may not include a general purpose central processing unit (CPU), a graphics processing unit (GPU), a microcontroller, a field-programmable gate array (FPGA), Complex Programmable Logic Device (CPLD), and/or an application-specific integrated circuit (ASIC).

The electronic storage 152 may be any type of electronic memory that is capable of storing data and instructions in the form of computer programs or software, and the electronic storage 152 may include volatile and/or non-volatile components. For example, the electronic storage 152 may store computer programs that, when executed, analyze information from the sensor 137, actuator 133, and/or the sensors 115. The electronic storage 152 also may include instructions that, when executed, control the voltage regulation device 108. For example, if the control system 150 has determined that the voltage regulation device 108 is in a safe to bypass state, the control system 150 inhibits all operations in the voltage regulation device 108 while the bypass switching assembly 120 is opening or closing. For example, the control system 150 may prevent the tap selector 114 from moving relative to the coil 112 and taps 113 while the bypass switching assembly 120 is opening or closing. In this way, the voltage regulation device 108 remains in the safe to bypass while the bypass switching assembly 120 changes state. The electronic storage 152 and the processing module 151 are coupled such that the processing module 151 is able to access or read data from and write data to the electronic storage 152.

The I/O interface 153 may be any interface that allows a human operator and/or an autonomous process to interact with the control system 150. The I/O interface 153 may include, for example, a display (such as a liquid crystal display (LCD)), a keyboard, audio input and/or output (such as speakers and/or a microphone), visual output (such as lights, light emitting diodes (LED)) that are in addition to or instead of the display, serial or parallel port, a Universal Serial Bus (USB) connection, and/or any type of network interface, such as, for example, Ethernet. The I/O interface 153 also may allow communication without physical contact through, for example, an IEEE 802.11, Bluetooth, or a near-field communication (NFC) connection. The control system 150 may be, for example, operated, configured, modified, or updated through the I/O interface 153.

The I/O interface 153 also may allow the control system 150 to communicate with systems external to and remote from the bypass switching assembly 120 and the voltage regulator device 108 via a data link 154. For example, the I/O interface 153 may include a communications interface that allows communication between the control system 150 and a remote station 170, or between the control system 150 and a separate electrical apparatus in the electrical power distribution system 100 other than the voltage regulation device 108 and the bypass switching assembly 120 using, for example, the Supervisory Control and Data Acquisition (SCADA) protocol or another services protocol, such as Secure Shell (SSH) or the Hypertext Transfer Protocol (HTTP). The data link 154 (shown with a dashed line) is any type of medium over which data, such as, for example, information, commands, or numerical data, is able to travel. The data may be in the form of electrical signals. The data links 154 may be formed with any type of wired or wireless medium that is capable of transmitting information. For example, the data link 154 may be electrical cables.

The remote station 170 is any type of station through which an operator is able to communicate with the control system 150 without making physical contact with the control system 150. For example, the remote station may be a computer-based work station, a smart phone, tablet, or a laptop computer that connects to the control system 150 via a services protocol, or a remote control that connects to the control system 150 via a radio-frequency signal or physical tether. The control system 150 may communicate information such as the determined tap position through the I/O interface 153 to the remote station 170 or to a separate electrical apparatus. In some implementations, the remote station 170 is physically connected to the control system 150 by an electrical cable or other type of tether.

The control system 150 may be housed in a housing that encloses the bypass switching assembly 120, a housing that encloses the voltage regulation device 108, or in a separate housing that is dedicated to the control system 150.

The electrical power distribution system 100 may be, for example, an electrical grid, an electrical system, or a multi-phase electrical network that provides electricity to commercial and/or residential customers. The electrical power distribution system 100 may have an operating voltage of, for example, at least 1 kilovolt (kV), up to 34.5 kV, up to 38 kV, up to 69 kV, or 69 kV or higher. The electrical power distribution system 100 is an alternating current (AC) electrical network and may operate at a fundamental frequency of, for example, 50-60 Hertz (Hz). The distribution path 106 may include, for example, one or more distribution lines, electrical cables, and/or any other mechanism for transmitting electricity

The electrical load 102 is any device or devices that utilizes electricity and may include electrical equipment that receives and transfers or distributes electricity to other equipment in the electrical power distribution system 100. The electrical load 102 may include, for example, transformers, switchgear, energy storage systems, computer and communication equipment, lighting, heating and air conditioning, motors and electrical machinery in a manufacturing facility, and/or electrical appliances and systems in a residential building.

The power source 101 is any source of electricity such as, for example, a power plant that generates electricity from fossil fuel or from thermal energy, or an electrical substation. The power source 101 may include one or more distributed energy resources, such as, for example, a solar energy system that includes an array of photovoltaic (PV) devices that convert sunlight into electricity or a wind-based energy system. More than one power source may supply electricity to the electrical power distribution system 100, and more than one type of power source may supply electricity to the electrical power distribution system 100.

FIGS. 2A-2F show various views of a bypass switching assembly 220. The bypass switching assembly 220 is an implementation of the bypass switching assembly 120 (FIG. 1A) and may be used with the voltage regulator device 108, the control system 150, and/or the remote station 170. FIGS. 2A and 2C show the bypass switching assembly 220 in a closed state. FIG. 2A is an unlocked state, and FIG. 2C is a locked state. FIG. 2E shows the bypass switching assembly in an open and unlocked state. The voltage regulation device and the control system 150 are not shown in FIGS. 2A-2F.

The bypass switching assembly 220 includes a first electrically conductive element 226, a second electrically conductive element 228, and an electrically conductive bypass element 230. The elements 226 and 228 are blade-like structures that extend in further in one direction than in a perpendicular direction. The bypass element 230 is a plate-like structure. The elements 226, 228, and 230 are made of an electrically conductive material, such as, for example, copper or another metallic material.

The elements 226 and 228 are mechanically coupled to each other by insulating bars 229 that extend in the Z direction. The bars 229 provide structural support and also separate the elements 226 and 228 in the Z direction. The elements 226 and 228 are connected to respective contacts 226A and 228A at respective pivot points 244a and 244b. The contact 226A is electrically connected to the source bushing 109 of the voltage regulator device 108, and the contact 228A is electrically connected to the load bushing 110 of the voltage regulator device 108. The pivot points 244a and 244b allow the elements 226 and 228 to move relative to the voltage regulation device 108 while the contacts 226A and 228A remain connected to the source bushing 109 and the load bushing 110, respectively.

The bypass element 230 has a hook or latch mechanism 243 that fits onto or latches onto to a corresponding rod 240. The rod 240 extends from the second electrically conductive element 228 in the −Z direction. The rod 240 may be substantially cylindrical in shape, and the latch mechanism 243 may be a structure that includes one or more deflectable elements that move to allow the rod 240 to be held by the latch mechanism 243 and released by the latch mechanism 243.

The bypass switching assembly 220 also includes an insulator 236. The insulator 236 is a three-dimensional object that extends along a longitudinal axis (in the Z direction) from a base 241 to a top end portion 242. The insulator 236 is able to rotate about the Z axis. The insulator 236 is made out of an electrically insulating material. The top end portion 242 is mechanically coupled to the first electrically conductive element 226 in a manner that allows the top end portion 242 to rotate about the pivot point 244a.

The bypass switching assembly 220 also includes a locking assembly that includes a linear actuator 238 and a limit switch 237 that measures the position of the insulator 236. The linear actuator 238 and the limit switch 237 are coupled to the control system 150 (FIG. 1A). The linear actuator 238 includes a plunger 239 that moves in the Z direction and the −Z direction. Referring also to FIGS. 2C and 2D, the base 241 of the insulator 236 includes a plurality of openings 246. The openings 246 are sized to receive the plunger 239. When the plunger 239 is received in an opening 246, the insulator 236 is locked and is unable to rotate about the Z axis. When the insulator 236 is locked, the first and second electrical conductive elements 226 and 228 are also unable to move and are locked in place.

To transition the bypass switching assembly 220 from the closed state to the opened state, the base 241 is unlocked by withdrawing the plunger 239 from the opening 246. In some implementations, the control system 150 commands the linear actuator 238 to move the plunger 239 in the −Z direction to unlock the insulator 236. In these implementations, the control system 150 only controls the linear actuator 238 to move the plunger 239 in the −Z direction if the voltage regulator connected to the bypass switching assembly 220 is in a safe to bypass state. In some implementations, the linear actuator 238 may be manually triggered or operated without the control system 150.

After the plunger 239 is moved in the −Z direction and is no longer in the opening 246, the insulator 236 is unlocked and the electrically conductive elements 226 and 228 are able to move. The electrically conductive elements 226 and 228 are rotated about the pivot points 244a and 244b, respectively, in the X-Y plane. The electrically conductive elements 226 and 228 may be rotated about the respective pivot points 244a and 244b by, for example, pulling a loop 248 along an arc A (FIG. 2C) in the X-Y plane. The loop 248 shown in FIGS. 2A, 2C, and 2E may be pulled by, for example, a hook stick. When the conductive elements 226 and 228 move along the arc A, the rod 240 also moves and pulls the bypass element 230. The bypass element 230 moves and electrically connects the source terminal 222 and the load terminal 224. FIG. 2E shows the bypass switching assembly 220 in the open state and unlocked (the plunger 239 is not inserted into any of the openings 246). To close the bypass switching assembly 220, the insulator 236 is unlocked by moving the plunger 236 in the −Z direction. The conductive elements 226 and 228 are pushed along the arc A toward the terminals 222 and 224. The rod 240 re-engages the latching mechanism 243 and the bypass element 230 is pushed out from between the terminals 222 and 224, and the bypass element 230 no longer electrically connects the terminal 222 to the terminal 224. Electrical current is then able to flow into the source bushing 109 of the regulator device 108 through the first electrically conductive element 226 and out of the load bushing 210 through the second electrically conductive element 228 such that the regulator device 108 is re-connected and is no longer bypassed.

The limit switch 237 measures the position or amount of rotation of the insulator 236 and provides an indication of the measurement to the control system 150. For example, after opening the bypass switching assembly 220, the control system 150 commands the linear actuator 238 to extend the plunger 239 in the Z direction such that one of the openings 246 is engaged in response to an indication from the limit switch that the insulator 236 has rotated sufficiently that the electrically conductive elements 226 and 228 are not in electrical contact with the source terminal 222 and load terminal 224, respectively.

Other implementations of the bypass switching assembly 220 are possible. For example, the bypass switching assembly 220 may include an electric motor that is coupled to the insulator 236 at the base 241.

FIGS. 3A and 3B are perspective views of a bypass switching assembly 320. The bypass switching assembly 320 is another implementation of the bypass switching assembly 120 (FIG. 1A). The bypass switching assembly 320 may be used with the voltage regulator device 108 and the control system 150 (FIG. 1A). FIG. 3A shows the bypass switching assembly 320 in a closed and locked state. FIG. 3B shows the bypass switching assembly 320 in an open and locked state.

The bypass switching assembly 320 includes a first electrically conductive element 326, a second electrically conductive element 328, and a bypass element 330. The first and second electrically conductive elements 326 and 328 are blade-like structures that extend in one dimension more than a perpendicular dimension. The bypass element 330 is a plate-like structure. The first and second electrically conductive elements 326 and 328 are mechanically connected to each other by insulating rods 329 that extend in the X direction. The rods 329 also separate the electrically conductive elements 326 and 328 from each other.

The bypass switching assembly 320 also includes a source terminal 322 and a load terminal 324. The source terminal 322 is electrically connected to a source of electrical energy (such as the source 101 of FIG. 1A). The load terminal 324 is electrically connected to a load (such as the load 102 of FIG. 1A). When the bypass switching assembly 320 is in the opened state (FIG. 3B), the bypass element 330 connects the source terminal 322 to the load terminal 324. When the bypass switching assembly 320 is in the opened state, the first electrically conductive element 326 is not electrically connected to the source terminal 322, and the second electrically conductive element 328 is not electrically connected to the load terminal 324. When the bypass switching assembly 320 is closed (FIG. 3A), the first electrically conductive element 326 is electrically connected to the source terminal 322 and the second electrically conductive element 328 electrically connected to the load terminal 324.

FIGS. 3C and 3D show the bypass element 330 in greater detail. The bypass element 330 has a hook rod 343 that fits onto to a corresponding push rod 340 on the second electrically conductive element 328. When the second electrically conductive element 328 is closed (in contact with the load terminal 324), the push rod 340 latches onto the hook rod 343 and pushes the bypass element 330 down (FIG. 3D) such that the bypass element 230 does not electrically connect the terminals 322 and 324 to each other. When the second electrically conductive element 328 is opened (removed from the load terminal 324), the push rod 340 pulls the hook rod 343 upwards to thereby cause the bypass element 230 to electrically connect the source terminal 322 and the load terminal 324 to each other. The second electrically conductive element 328 then separates away from hook rod 343 (FIG. 3C).

Referring again to FIGS. 3A and 3B, the bypass switching assembly 320 also includes an interlock assembly 335. The interlock assembly 335 includes an insulator 336 that extends in the Z direction from a base 341 to a top end portion 342. The rotating insulator 336 is able to rotate about the Z axis. The bypass switching assembly 320 also includes an actuator 333, which is coupled to the base 341 of the insulator 336. The actuator 333 is coupled to the control system 150 via the data link 154. The actuator 333 is controllable to cause the insulator 336 to rotate about the Z axis. The actuator 333 may be, for example, a motor or a system of gears. Sensors 337 at the base 341 track the amount of rotation of the insulator 336. The sensors 337 may be limit switches.

The interlock assembly 335 also includes hook structure 339, a disk 361 with a plurality of openings 346, and a crank 360. The crank 360 is coupled to the second electrically conductive element 328 and the disk 361. When the second electrically conductive element 328 moves about a pivot point 363, the crank 360 causes the disk 361 to rotate and the openings 346 move. The hook structure 339 is mounted on the top end portion 342. Rotating the insulator 336 also causes the hook structure 339 to move along an arc in the X-Y plane. The hook structure 339 is sized to engage one of the openings 346. When the hook structure 339 engages one of the openings 346, the disk 361, the crank 360, and the second electrically conductive element 328 are unable to move and the bypass switching assembly 320 is thus locked.

To open the bypass switching assembly 320, first the control system determines whether it is safe to bypass the voltage regulation device 108. If the voltage regulation device 108 is in a safe to bypass condition, the actuator 333 is controlled to rotate clockwise (looking in the Z direction) such that the hook structure 339 also moves clockwise and is removed from the opening 346. The first and second electrically conductive elements 326 and 328 are then removed from the source terminal 322 and load terminal 324, respectively, by rotating the second electrically conductive element 328 about the pivot point 363 along an arc A (FIG. 3B) in the Y-Z plane. When the second electrically conductive element 328 moves along the arc A, the first electrically conductive element 326 rotates about a pivot point 365. The pivot points 363 and 365 are part of a pivot assembly. The pivot points 363 and 365 are mounted to a structure 392. The structure 392 is separate from the insulator 336. The conductive elements 326 and 328 are rotated about the respective pivot points 365 and 363 by pulling a hook 348 along the arc A. The hook 348 may be pulled manually by, for example, a hook stick. When the first and second electrically conductive elements 326 and 328 are rotated about the respective pivot points 365 and 363, the crank 360 (which is mechanically coupled to the second electrically conductive element 328) causes the disk 361 to turn such that a different opening 346 is aligned with the hook structure 339. The actuator 333 rotates the insulator 336 in the counterclockwise direction such that the hook structure 339 engages the different opening 346 and the bypass switching apparatus is locked in the opened state (such as shown in FIG. 3B). To close the bypass switching assembly 320, the sequence is performed in reverse order.

Other implementations of the bypass switching assembly 320 are possible. For example, in implementations in which the actuator 333 is a motor, the bypass switching assembly 320 may be implemented without the sensors 337. For example, the motor 333 may communicate its position directly to the control system 150 without the need for a position sensor 337. In these implementations, the motor 333 is coupled to the control system 150 and the control system 150 controls the motion of the motor 333.

Moreover, the bypass switching assembly 320 may include different elements than those shown in the example of FIGS. 3A-3D and may include a different type of interlock assembly. For example, the bypass switching assembly 320 may include a gear system such as the gear system 674 shown in FIGS. 6A and 6B. In these implementations, the gear system is mounted at the top portion 342 of the insulator 336 and acts to transfer motion between the insulator 336 and the second electrically conductive element 328. Further, in these implementations, the linear actuator 238 and plunger 239 (FIGS. 2A-2F) are used as the interlock assembly instead of the hook structure 339, the crank 360, and the disk 361. For example, the insulator 336 may include openings at the base 341 that receive a plunger such as the plunger 239 (FIGS. 2A-2F). The insulator 236 is connected to the gear system 674. When the insulator 336 rotates, the rotation of the insulator 236 is transferred to the second electrically conductive element 328 such that the electrically conductive element 328 moves.

FIGS. 4A-4F show various views of a bypass switching assembly 420. The bypass switching assembly 420 is another implementation of the bypass switching assembly 120 (FIG. 1A). The bypass switching assembly 420 is the same as the bypass switching assembly 320 (FIGS. 3A and 3B), except the first electrically conductive element 426 and the second electrically conductive element 428 are independently movable and are not mechanically coupled to each other.

The bypass switching assembly 420 includes the interlock assembly 335 discussed with respect to FIGS. 3A and 3B. FIG. 4A shows the bypass switching assembly 420 in a closed state and locked. FIG. 4B shows the interlock assembly 335 in a locked state. FIG. 4C shows the bypass switching assembly 420 in an opened and locked state. FIG. 4D shows the interlock assembly 335 in a locked state. FIG. 4E shows the bypass switching assembly 420 in a closed state and unlocked. FIG. 4F shows the interlock assembly 335 in an unlocked state.

The bypass switching assembly 420 includes a first electrically conductive element 426 and a second electrically conductive element 428. The second electrically conductive element 426 is connected to the crank 360 at a pivot point 463. The crank 360 is connected to the disk 361, which includes the openings 346. When the second electrically conductive element 428 rotates about the pivot point 463, the crank 360 moves and also causes the disk 361 and the openings 346 move. The first electrically conductive element 426 rotates about a pivot point 465. The first electrically conductive element 426 is not connected to the crank 360 or the disk 361.

To close the bypass switching assembly 420, the first electrically conductive element 426 is pivoted about the pivot point 465 and placed in contact with the source terminal 322. This provides electrical power to the coil 112 in the voltage regulation device 108, and the control system 150 determines whether the voltage regulation device 108 is in a safe to bypass condition. If the voltage regulator device 108 is in a safe to bypass condition, the control system 150 determines the position of the insulator 336 and the hook structure 339. If the position of the insulator 336 is such that the hook structure 339 is engaged with one of the openings 346, the actuator 333 causes the insulator 336 to rotate such that the hook structure 339 is removed from the opening 346 and the second electrically conductive element 428 is unlocked. The second electrically conductive element 428 is rotated about the pivot point 463 and placed in contact with the load terminal 324. The crank 360 moves with the element 428 and rotates the disk 361. The actuator 333 rotates the insulator 336 such that the hook structure 339 engages a different one of the openings 346 in the disk 361 to lock the second electrically insulating element 428 in place. The process is followed in reverse to open the bypass switching assembly 420. That is, in an opening sequence, the second electrically conductive element 428 is connected to the load terminal 324 before the first electrically conductive element 426 is connected to the source terminal 326.

FIGS. 5A and 5B show a bypass switching assembly 520. FIG. 5A is a side view of the bypass switching assembly 520 in the Y-Z plane. FIG. 5B is a top view of the bypass switching assembly 520 in the X-Y plane. The bypass switching assembly 520 is another implementation of the bypass switching assembly 120 (FIG. 1A). The bypass switching assembly 520 includes the interlock assembly 335 (which is discussed above), a source terminal 522, and a load terminal 524. The bypass switching assembly 520 includes a first electrically conductive element 526 and a second electrically conductive element 528. The first and second electrically conductive elements 526 and 528 are mechanically connected to each other by insulating rods 529 that extend in the X direction. The second electrically conductive element 528 is connected to the crank 360 of the interlock assembly 335 at a pivot point 563. The bypass switching assembly 520 also includes a source conductor 568. The source conductor 568 is made of an electrically conductive material, such as copper or another metallic material. The source conductor 568 is connected to a pivot point 572. The source conductor 568 is not connected to the interlock assembly 535, the first electrically conductive element 526, or the second electrically conductive element 528. The source conductor 568 is able to move independently from the first and second electrically conductive elements 526 and 528.

FIGS. 5A and 5B show the bypass switching assembly 520 in the closed and locked state, with the hook structure 339 engaged with one of the openings 346 on the disk 361. When the bypass switching assembly 520 is in the closed state, the source conductor 568 is electrically connected to the source terminal 522 and to the source bushing 109 of the voltage regulation device 108. The source conductor 568 is electrically connected to the source terminal 522 by an electrically conductive element 570 that extends along the X direction between the source conductor 568 and the source terminal 522. The first electrically conductive element 526 is also electrically connected to the source terminal 522 and the source bushing 109. Thus, when the bypass switching assembly 520 is closed, the first electrically conductive element 526 and the source conductor 568 are in parallel with each other.

To open the bypass switching assembly 520, the source conductor 568 is rotated about the pivot point 572. The actuator 333 rotates the insulator 336 such that the hook structure 339 is removed from the opening 346 and the bypass switching assembly 520 is unlocked. The first electrically conductive element 526 and the second electrically conductive element 528 are mechanically connected to each other but are mounted to separate pivot points 565 and 563, respectively. The first electrically conductive element 526 is rotated about the pivot point 565 and the second electrically conductive element 528 is rotated about the pivot point 563 to disconnect from the source terminal 522 and the load terminal 524, respectively. The actuator 333 rotates the insulator 336 such that the hook structure 339 engages one of the openings 346 and the first and second electrically conductive elements 526 and 528 are locked in the open position.

To close the bypass switching assembly 520, the source conductor 568 is rotated about the pivot point 572. This provides power to the sensors 115 in the voltage regulator device such that the control system 150 is able to determine whether the voltage regulator device is safe to operate. If the voltage regulator device is safe to operate, then the actuator 333 rotates the insulator 336 to unlock the first and second electrically conductive elements 526 and 528. The first electrically conductive element 526 is rotated about the pivot point 565, and the second electrically conductive element 528 is rotated about the pivot point 563 such that the first electrically conductive element 526 and the second electrically conductive element 528 make contact with the source terminal 522 and the load terminal 524, respectively.

Other implementations of the bypass switching assembly 520 are possible. For example, the actuator 333 may be a motor that reports its position or information that indicates its position to the control system 150 such that the bypass switching assembly 520 may be implemented without the sensors 337.

Moreover, the bypass switching assembly 520 may include different elements than those shown in the example of FIGS. 5A and 5B and may include a different type of interlock assembly. For example, the bypass switching assembly 520 may include a gear system such as the gear system 674 shown in FIGS. 6A and 6B. In these implementations, the gear system is mounted at the top portion 342 of the insulator 336 and acts to transfer motion between the insulator 336 and the second electrically conductive element 328. Further, in these implementations, the linear actuator 238 and plunger 239 (FIGS. 2A-2F) are used as the interlock assembly instead of the hook structure 339, the crank 360, and the disk 361. For example, the insulator 336 may include openings at the base 341 that receive a plunger such as the plunger 239 (FIGS. 2A-2F). The insulator 236 is connected to the gear system. When the insulator 336 rotates, the rotation of the insulator 236 is transferred to the second electrically conductive element 528 such that the electrically conductive element 528 moves.

FIGS. 6A and 6B show top and side views, respectively, of a bypass switching assembly 620. The bypass switching assembly 620 is another implementation of the bypass switching assembly 120 (FIG. 1A). The bypass switching assembly 620 includes a first electrically conductive element 626 and a second electrically conductive element 628. The first electrically conductive element 626 and the second electrically conductive element 628 are not mechanically coupled to each other. Thus, the elements 626 and 628 are able to move independently of each other.

The first electrically conductive element 626 is connected to a pivot point 665. The second electrically conductive element 628 is connected to a pivot point 663. The bypass switching assembly 620 includes an interlock assembly 635. The interlock assembly 635 includes the insulator 236 (discussed above with respect to FIGS. 2A-2F), and a gear system 674. The gear system 674 includes a rack gear 675 and a pinion gear 677. The pinion gear 677 is mounted to the top end portion 242 of the insulator 236. When the second electrically conductive element 628 moves about the pivot point 663, the rack gear 675 moves and causes the pinion gear 677 to rotate. The rotation of the pinion 677 causes the insulator 236 to rotate. The insulator 236 may be locked by controlling the linear actuator 238 to extend the plunger 239 through one of the openings 246.

Other implementations of the bypass switching assembly 620 are possible. For example, the bypass switching assembly 620 may be used with a motor (such as the motor 333 of FIGS. 3A and 3B). In these implementations, the motor is coupled to the insulator 236 such that the motor causes the insulator 236 to rotate about the Z axis. When the motor rotates the insulator 236, the gear system 674 transfers the rotational motion of the insulator 236 to the second electrically conducting element 628. As a result, the second electrically conducting element 628 and the first electrically conducting element 626 (which is mechanically coupled to the second electrically conducting element 628) rotate about the respective pivot points 563 and 565 in response to the motor rotating the insulator 236. The motor is also coupled to the control system 150, and the control system 150 controls the action of the motor. In these implementations, the motor may report its position or information that indicates its position to the control system 150 such that the bypass switching assembly 620 may be implemented without the sensors 337.

Furthermore, the insulator 236 is unable to move unless moved intentionally by the motor. Thus, implementations in which the rotation of the insulator 236 is controlled by the motor do not necessarily include the plunger 239 or the openings 246.

FIG. 7 shows a perspective view of a source terminal 722 and a load terminal 724. The source terminal 722 and the load terminal 724 may be used as the source terminal and load terminal on any of the bypass switching assemblies discussed above. When the voltage regulation device 108 (FIG. 1A) is bypassed in off Neutral conditions, current in the coil 112 becomes very high because the coil 112 has very low intrinsic impedance. Hence, even for small voltage drops, the current becomes very high and may cause arcing incidents. Temporarily increasing the resistance of coil 112 may avoid having large amounts of current flowing through the coil 112 or may reduce the amount of current flowing through the coil 112. The resistance of the coil 112 may be temporarily increased by coating the source terminal 722 and the load terminal 724 with a high resistance electrically conducting material 780 which may be, for example, constantan or a copper alloy. In some implementations, the material 780 is a structural feature that increases resistance. For example, the material 780 may be ridges of an electrically conductive material or a roughened area of an electrically conductive material. The material 780 is on only a portion of source terminal 722 and the load terminal 724 where blades (for example, such as the first and second electrical conductors discussed above) are connected when the bypass switching assembly is closed. In this way, resistance of the coil 112 will be increased temporarily until the blades are completely closed.

FIG. 8A is a perspective view of a bypass switching assembly 820, and FIG. 8B is a side view of the assembly 820. The bypass switching assembly 820 is similar to the assembly 220 (FIGS. 2A-2F), except the assembly 820 includes a motor 884 that is controllable to rotate the insulator 236. The motor 884 may be remotely operated such that a human operator is not needed to open or close the bypass switching assembly 820.

Other features are within the scope of the claims.

What is claimed is:

1. A bypass switching assembly comprising:
a source terminal configured for connection to an electrical source;
a load terminal configured for connection to a load;
a switch comprising:
a first electrically conductive element;
a second electrically conductive element; and
an electrically conductive bypass element; and
an interlock assembly comprising:
an insulator configured to rotate; and
a locking assembly configured to interact with the insulator to prevent movement or permit movement of at least one of the first electrically conductive element and the second electrically conductive element.

2. The bypass switching apparatus of claim 1, wherein the interlock assembly further comprises: a sensor configured to sense a position of the insulator and to generate an indication of the position of the insulator, and the locking assembly prevents or permits movement based on the indication of the position of the insulator.

3. The bypass switching assembly of claim 1, wherein the switch has at least a closed state and an opened state; and
in the closed state, the first electrically conductive element is electrically connected to the source terminal, the second electrically conductive element is electrically connected to the load terminal, and the electrically conductive bypass element is not electrically connected to the source terminal and the load terminal; and
in the open state, the first electrically conductive element is not electrically connected to the source terminal, the second electrically conductive element is not electrically connected to the load terminal, and the electrically conductive bypass element is electrically connected to the source terminal and the load terminal.

4. The bypass switching assembly of claim 1, further comprising a pivot assembly, and wherein the first electrically conductive element and the second electrically conductive element are coupled to the pivot assembly; and wherein the insulator extends along a longitudinal axis from a base to a top end portion.

5. The bypass switching assembly of claim 4, wherein the first and second electrically conductive elements rotate about the pivot assembly in a plane that is perpendicular to the longitudinal axis.

6. The bypass switching assembly of claim 4, wherein at least one of the first electrically conductive element and the second electrically conductive element is mechanically coupled to the insulator, and the locking assembly is configured to prevent movement of at least one of the first and second electrically conductive elements by engaging the base and to permit movement of at least one of the first and second electrically conductive elements by disengaging the base.

7. The bypass switching assembly of claim 6, wherein the locking assembly comprises linear actuator comprising a plunger, the base comprises openings configured to receive the plunger, and the actuator is configured to prevent movement of the insulator and at least one of the first electrically conductive element and the second electrically conductive element by moving the plunger into one of the openings.

8. The bypass switching assembly of claim 7, further comprising a sensor mechanically coupled to the base and configured to provide an indication of a position of the insulator.

9. The bypass switching assembly of claim 4, wherein the first and second electrically conductive elements rotate about the pivot assembly in a plane that is parallel to the longitudinal axis.

10. The bypass switching assembly of claim 9, wherein the locking assembly comprises a hook mechanically connected to the top end portion of the insulator such that the hook rotates with the insulator, and the hook is configured to latch into one of a plurality of holes on a disk to thereby restrict movement of one or more of the first electrically conductive element and the second electrically conductive element.

11. The bypass switching assembly of claim 10, further comprising a motor configured to cause the insulator to rotate.

12. The bypass switching assembly of claim 1, wherein the first electrically conductive element and the second electrically conductive element are configured to move independently of each other.

13. The bypass switching assembly of claim 1, wherein the first electrically conductive element and the second electrically conductive element are mechanically coupled to each other and are configured to move together.

14. The bypass switching assembly of claim 1, further comprising a gear system coupled to the insulator and to one or more of the first electrically conductive element and the second electrically conductive element.

15. The bypass switching assembly of claim 14, wherein the gear system comprises a first gear mounted on the insulator and a second gear coupled to the first gear, and the second gear is coupled to one or more of the first electrically conductive element and the second electrically conductive element.

16. The bypass switching assembly of claim 15, wherein the first gear comprises a pinion gear, and the second gear comprises a rack gear.

17. The bypass switching assembly of claim 15, further comprising an actuator configured to cause the insulator to rotate.

18. The bypass switching assembly of claim 17, wherein the gear system transfers rotational motion of the insulator to one or more of the first electrically conductive element and the second electrically conductive element such that the motion of one or more of the first electrically conductive element and the second electrically conductive element is controllable by controlling the actuator.

19. The bypass switching assembly of claim 17, wherein the actuator comprises a motor.

20. The bypass switching assembly of claim 19, wherein the locking mechanism comprises a linear actuator and a plunger, insulator comprises openings configured to receive the plunger.

21. The bypass switching assembly of claim 2, wherein the first electrically conductive element is electrically connected to a source bushing of a voltage regulator, and the second electrically conductive element is electrically connected to a load bushing of the voltage regulator; and the bypass switching assembly further comprises a control system coupled to the actuator and the sensor, wherein the control system is configured to analyze the generated indication of the position of the insulator and an electrical measurement of the voltage regulator and to control the actuator based on the indicated position of the insulator and the electrical measurement of the voltage regulator.

22. The bypass switching assembly of claim 1, further comprising a motor.

23. The bypass switching assembly of claim 21, wherein the insulator is rotated by the motor.

24. The bypass switching assembly of claim 23, wherein the motor is the locking assembly.

25. The bypass switching assembly of claim 24, wherein one or more of the first electrically conductive element and the second electrically conductive element is moved by the insulator.

26. The bypass switching assembly of claim 22, wherein the motor is controllable from a remote system that is external to the bypass switching assembly.

27. The bypass switching assembly of claim 26, wherein the remote system is remotely connected to a transceiver in the bypass switching assembly via a wireless connection or a physical tether.

28. The bypass switching assembly of claim 1, wherein the source terminal comprises a first material having a first impedance, the load terminal comprises a material having a second impedance, a portion of the source terminal comprises a first substance that has a greater electrical impedance than the first impedance, and a portion of the load terminal comprises a second substance that has a greater electrical impedance than the second impedance.

29. The bypass switching assembly of claim 28, wherein the first substance and the second substance comprises a resistive coating.

30. The bypass switching assembly of claim 28, wherein the coating comprises a copper alloy.

31. The bypass switching assembly of claim 28, wherein the first substance and the second substance comprises a ridged or roughened surface on a portion of the source terminal and a portion of the load terminal.

32. A system comprising:
a voltage regulator comprising:
a source bushing;
a load bushing; and
a winding between the source bushing and the load bushing; and
a bypass switching assembly comprising:
a source terminal configured for connection to an electrical source;
a load terminal configured for connection to a load;
a switch comprising:
a first electrically conductive element electrically connected to the source bushing of the voltage regulator and configured to be connected to or disconnected from the source terminal of the bypass switching assembly;
a second electrically conductive element electrically connected to the load bushing of the voltage regulator and configured to be connected to or disconnected from the load terminal of the bypass switching assembly; and
an electrically conductive bypass element;
an interlock assembly comprising:
an insulator configured to rotate; and
a locking assembly configured to prevent movement or permit movement of at least one of the first electrically conductive element and the second electrically conductive element; and
a control system coupled to the voltage regulator and the bypass switching assembly, wherein the control system is configured to:
determine whether the voltage regulator is in a safe to bypass state, and
to only allow the interlock assembly to permit movement when the voltage regulator is in the safe to bypass state.
